(19) United States
(12) Patent Application Publication
(10) Pub. No.: US 2009/0244711 A1
(43) Pub. Date: Oct. 1, 2009

(54) IMAGING FILTER

(75) Inventors: Iwao Yokoyama, Sano-shi (JP); Noriyoshi Hirose, Sano-shi (JP); Hajime Kurahashi, Sano-shi (JP)

Correspondence Address: BIRCH STEWART KOLASCH & BIRCH, PO BOX 747, FALLS CHURCH, VA, 22040-0747, US

(73) Assignee: FUJINON CORPORATION, Saitama-shi (JP)

(21) Appl. No.: 12/408,339

(22) Filed: Mar. 20, 2009

(30) Foreign Application Priority Data
Mar. 21, 2008 (JP) 2008-073705

(51) Int. Cl. G02B 5/26

(52) U.S. Cl. 359/613

(57) ABSTRACT

An imaging filter disposed on a front surface of an image sensor and serving to limit an incident angle of light on the image sensor is provided. The filter includes: a transparent substrate; a first shielding film provided on the front surface of the substrate and having a plurality of incidence openings, the incidence openings having a constant size and provided at an interval; a second shielding film provided on a back surface of the substrate and having a plurality of emission openings, the emission openings having a constant size and having centers which are coincident with the incidence openings; and a reflecting film provided on at least one of the front surface and the back surface of the substrate and including a multilayer dielectric film that transmits light having a wavelength and being incident almost vertically on the reflecting film and that that reflects the light having the wavelength and being incident obliquely on the reflecting film.

This application is based on and claims priority under 35 U.S.C. § 119 from Japanese Patent Application No. 2008-073705, filed on Mar. 21, 2008, the entire disclosure of which is herein incorporated by reference.

### BACKGROUND OF THE INVENTION

1. Field of the Invention

The present invention relates to an imaging filter to be used in a contact type imaging apparatus for causing an image sensor to come in close contact with an object, thereby carrying out imaging, and more particularly to an imaging filter for limiting an incident angle of light on the image sensor of the imaging apparatus.

2. Description of Related Art

An image scanner for taking an image of an original such as a picture or a document to obtain digital image data has spread. For the image scanner, there has been known a contact type image scanner which causes a line image sensor having an equal width to an original to be read to come in almost contact with the original, thereby carrying out imaging. The contact type image scanner is constituted to have a small distance from the original to the image sensor and to be more compact than an image scanner of another type which uses a reducing optical system.

If a lens for forming an image of the original is not used but the image sensor is simply disposed in close contact with the original, light emitted from a certain point of the original does not reach a single pixel but is also incident on a plurality of peripheral pixels together with a pixel to be originally incident. For this reason, also in the contact type image scanner, a cylindrical rod lens having a refractive index distributed with a decrease from a center to a periphery is disposed between the image sensor and the original to limit an incidence of light on the image sensor in such a manner that light emitted from a certain point of the original can reach a single imaging area having the image sensor almost one-on-one.

As an imaging apparatus for limiting the incidence of light on the image sensor, there has been known an imaging apparatus using an imaging filter for limiting an incident angle of light on the image sensor in order to use a light receiving area of the image sensor with a division into a plurality of portions. For example, there have been known an image sensor in which a shielding block is disposed corresponding to light receiving area to be divided (JP-A-2007-121631) and an imaging apparatus in which a grid plate having a slit is provided to divide light receiving area to take a rectangular shape (JP-A-2007-299085). There has been known a film camera in which a perforated plate having a large number of through holes is provided to limit an incident angle of light on a light receiving area in such a manner that only a parallel ray incident vertically on the light receiving area is incident on the film (JP-A-2004-151124).

In the contact type image scanner, it is impossible to prevent a clearance from being formed between an imaging target and an image sensor. A photodiode is placed in a deeper position than a surface of the image sensor. For this reason, light emitted from a single point of the imaging target is obliquely incident on both of adjacent photodiodes, resulting in a noise or a false signal. Accordingly, it is necessary to limit an incident angle of the light on the image sensor in such a manner that the light emitted from the single point is incident on only one photodiode in order to carry out fine imaging.

In order to prevent the light emitted from the single point from being incident on the adjacent photodiodes or adjacent light receiving areas, it is necessary to limit the incident angle of the light which is incident on the image sensor by using a rod lens utilized in the contact type image scanner or using an imaging filter for dividing a light receiving area by a through hole, for example, imaging filters described in JP-A-2007-121631 and JP-A-2007-299085.

However, when the rod lens is used, it is necessary to form a comparatively large incorporation space in a vertical direction. For this reason, it is hard to further reduce a thickness.

An imaging filter having a through hole such as a slit is fabricated by a metallic plate. If a diameter of the through hole is decreased and an interval between the through holes is reduced, it is more difficult to carry out a processing for forming the through hole. Even if a very small through hole can be provided by a mechanical processing, the cost is increased for the imaging filter. In addition, when a part of the incident light is reflected from (or transmitted through) an internal wall of the through hole, light emitted to the outside of a region determined by the diameter of the through hole is generated. For this reason, it is necessary to carry out an antireflection processing over the internal wall of the through hole. However, it is hard to carry out a special processing over the internal wall in case of the very small through hole which is hard to form.

Referring to the imaging filter provided with a through hole having a small diameter, clogging is apt to be caused by refuse or dust in a manufacturing process or an incorporation into the image scanner, and it is hard to remove the refuse which once enters the through hole. For this reason, in the imaging filter provided with a through hole having a small diameter, it is necessary to take an ambient environment in handling into consideration, and the imaging filter provided with the through hole and the image scanner using the imaging filter have poor yield and a stable mass production is hard to perform.

### SUMMARY OF THE INVENTION

In consideration of the above, an object of the invention is to provide an imaging filter in which a mass production adequacy is excellent, a manufacturing cost can be reduced, an incorporation space in a vertical direction is also small, and an incident angle of light on an image sensor is limited.

An imaging filter of the invention includes: a transparent substrate; a shielding film provided on a surface of the substrate, having a plurality of openings formed with a constant size and at a constant interval, and shielding light incident on a portion other than the openings; and a reflecting film provided on the surface of the substrate, formed of a multilayer dielectric film, and serving to transmit light having a wavelength and being incident vertically on the reflecting film and to reflect light having the wavelength and being incident obliquely on the reflecting film, wherein an incident angle of light on an image sensor is limited.

The shielding film may be provided on one of the surface of the substrate facing an object and the surface of the substrate facing the image sensor.

In this case, the reflecting film may be provided on the shielding film so as to cover all the openings.

The shielding film may be provided on one surface of the substrate and the reflecting film may be provided on the other surface of the substrate.

The shielding film may be provided on both surfaces of the substrate so that center positions of the openings of the shielding film coincide with each other in the inside and the outside of the substrate.

In this way, when the shielding film is provided on both surfaces of the substrate, the diameter of the openings provided on the surface of the substrate facing the image sensor may be smaller than the diameter of the openings of the shielding film provided on the surface of the substrate facing the object.

In addition, when the shielding film is provided on both surfaces of the substrate, the reflecting film may be provided on the shielding film provided on the surface of the substrate facing the image sensor so as to cover all the openings of the shielding film provided on the surface of the substrate facing the image sensor.

When the shielding film is provided on both surfaces of the substrate, the reflecting film may be provided on the shielding film provided on the surface of the substrate facing the object so as to cover all the openings of the shielding film provided on the surface of the substrate facing the object.

The shielding film may be an absorbing film absorbing the light having the wavelength.

The reflecting film may be an infrared ray cut filter film transmitting an infrared ray incident almost vertically on the reflecting film and reflecting the infrared ray incident obliquely on the reflecting film.

The substrate may be a non-polished glass substrate.

### BRIEF DESCRIPTION OF THE DRAWINGS

The features of the invention will appear more fully upon consideration of the exemplary embodiment of the invention, which are schematically set forth in the drawings, in which:

FIG. 1 is an explanatory view schematically showing a structure of a contact type scanner;

FIG. 2 is a perspective view schematically showing a structure of an imaging apparatus using an angle limiting filter;

FIG. 3 is a sectional view showing an angle limiting filter;

FIG. 4 is a graph showing a characteristic of an incident angle-dependent reflecting film;

FIG. 5 is an explanatory view showing an action of the angle limiting filter;

FIG. 6 is a sectional view showing an angle limiting filter having the incident angle-dependent reflecting film provided on both surfaces;

FIG. 7 is a sectional view showing an angle limiting filter according to a first embodiment of the invention;

FIGS. 8A and 8B are sectional views showing a modified example of the angle limiting filter according to the first embodiment of the invention;

FIG. 9 is a sectional view showing a modified example of the angle limiting filter according to the second embodiment of the invention;

FIGS. 10A and 10B are sectional views showing a modified example of the angle limiting filter according to the second embodiment of the invention; and

FIG. 11 is a sectional view showing a modified example of the angle limiting filter according to the second embodiment of the invention;

### DESCRIPTION OF THE REFERENCE NUMERALS AND SIGNS

10 contact type scanner
11 object
13 LED
14 band-pass filter
15, 35, 36, 37, 38, 41, 46, 47, 48 angle limiting filter (imaging filter)
16 image sensor
17 pixel
18 incident light
19 vertical incident light
21 shielding area
22 transmitting area
26 glass substrate
27 first shielding film
28 second shielding film
29 incident angle-dependent reflecting film
31 incidence opening
32 emission opening
42 shielding film
43 opening

### DETAILED DESCRIPTION OF THE EXEMPLARY EMBODIMENTS

According to an exemplary embodiment of the invention, it is possible to provide an imaging filter in which the incident angle of light on the image sensor is easily limited, a mass production adequacy is excellent, a manufacturing cost is reduced and an incorporation space in a vertical direction is small when the image sensor is caused to come in close contact with an imaging target and a light receiving area is divided into very small regions including approximately one to several pixels to use the image sensor.

### First Embodiment

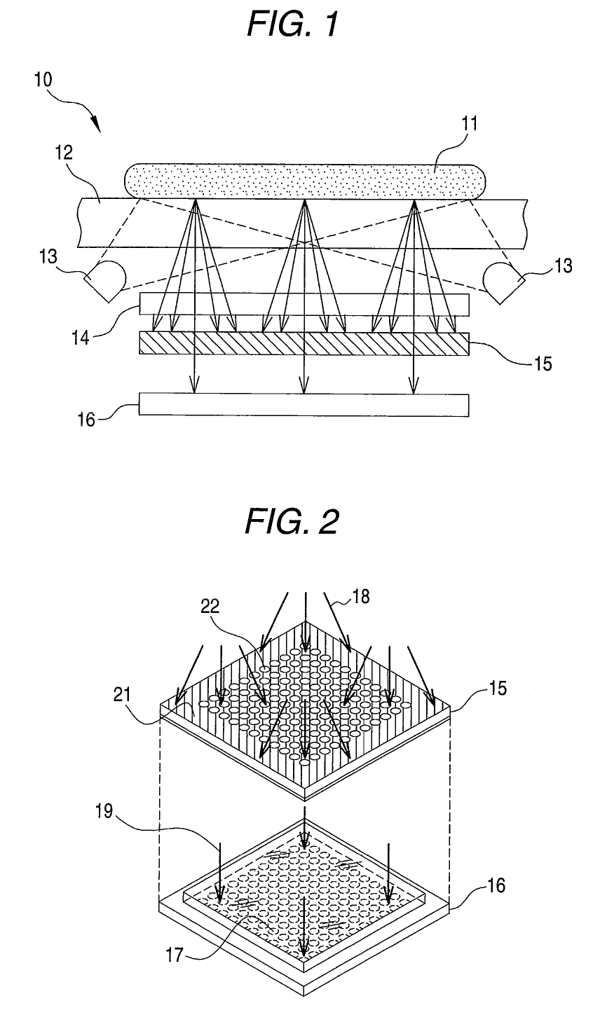

As shown in FIG. 1, a contact type scanner 10 is an imaging apparatus for taking an image of an object 11 which is caused to come in almost close contact with an image sensor 16 and includes a protecting cover 12, an LED 13, a band-pass filter 14, an angle limiting filter 15 and the image sensor 16. The protecting cover 12 is a transparent glass plate and protects the angle limiting filter 15 and the image sensor 16 which are disposed thereunder from flaw or dust. The object 11 which is to be subjected to imaging is directly mounted on the protecting cover 12.

The LED 13 emits an infrared ray having a wavelength of 850 nm and uniformly illuminates the object 11 mounted on the protecting cover 12. The infrared ray emitted from the LED 13 is scattered to reflect an absorptance and a reflectance of the infrared ray which are varied depending on a place of the object 11, and a part thereof is incident in a direction of the angle limiting filter 15 provided under the protecting cover 12. At this time, the light incident on the angle limiting filter 15 from the object 11 includes a component incident vertically as well as a component incident obliquely to the angle limiting filter 15.

The band-pass filter 14 transmits an infrared ray to be used for imaging and shields a visible light and an ultraviolet ray which are incident from an outside through the protecting cover 12. Consequently, the light incident on the angle limiting filter 15 and the image sensor 16 is limited to only the infrared ray to be utilized for the imaging. The angle limiting filter 15 (the imaging filter) shields any of incident light obliquely incident at various angles from the object 11, and transmits only light incident on the image sensor 16 almost vertically to the image sensor 16 as will be described below. The image sensor 16 is a CCD type area image sensor having a sensitivity to an infrared ray having a wavelength in the vicinity of 850 nm and taking an image of the object 11 with light having an incident angle limited to an almost vertical angle to a surface through the angle limiting filter 15.

As shown in FIG. 2, the angle limiting filter 15 transmits, to the image sensor 16, a vertical incident light 19 which is incident almost vertically to the surface in light 18 which is incident at various angles from the object 11, and shields the light 18 which are incident obliquely. A surface of the angle limiting filter 15 is provided with a shielding area 21 for shielding the incident light 18 and a transmitting area 22 for transmitting the incident light 18. The shielding area 21 is provided to cover almost the whole surface of the angle limiting filter 15, and the transmitting areas 22 are arranged in the shielding area 21. Light incident on the shielding area 21 is neither reflected nor transmitted but is absorbed. Each of the transmitting areas 22 is provided circularly in an almost equal size to that of a pixel 17 of the image sensor 16 and is arranged in such a manner that the transmitting area 22 corresponds to the pixel 17. The angle limiting filter 15 is aligned and disposed in such a manner that each of the transmitting areas 22 is positioned just above the corresponding pixel 17. In FIG. 2, for description, the angle limiting filter 15 is provided apart from the image sensor 16. However, the angle limiting filter 15 is disposed in close contact with the image sensor 16 through another optical filter which is not shown.

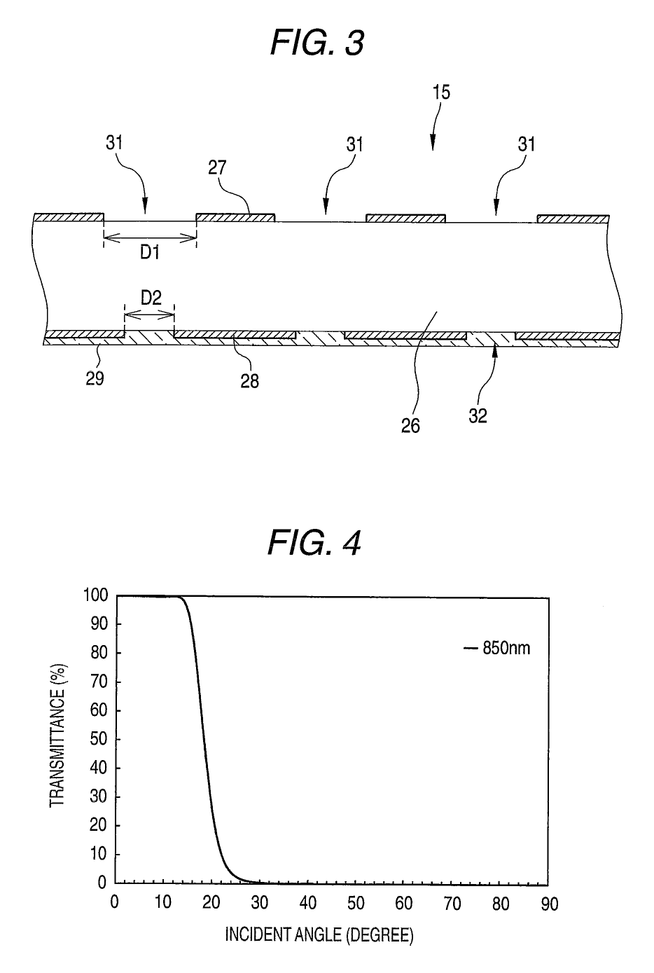

As shown in FIG. 3, the angle limiting filter 15 is constituted by a transparent plate-shaped glass substrate 26, a first shielding film 27, a second shielding film 28 and an incident angle-dependent reflecting film 29. The glass substrate 26 has a thickness of 0.15 mm and transmits almost all of the light within various wavelength ranges, for example, a visible light and an ultraviolet ray as well as the infrared ray having a wavelength in the vicinity of 850 nm which is utilized for imaging through the image sensor 16.

The first shielding film 27 is formed by alternately stacking a metal film having a great absorption coefficient and a transparent dielectric film in large numbers and is provided on a surface (a front surface) of the glass substrate 26 facing the object 11. The first shielding film 27 is an absorbing film absorbing almost all light in a wavelength range having sensitivity to the image sensor 16 in addition to the infrared ray having a wavelength in the vicinity of 850 nm which is utilized for the imaging through the image sensor 16. A plurality of incidence openings 31 is formed on the first shielding film 27 and a portion for transmitting an incident light therethrough is limited to the incidence opening 31. Each of the incidence openings 31 takes a circular shape and is arranged at a regular interval in such a manner that a central position is coincident with a center of the pixel 17. When the angle limiting filter 15 is seen from a front surface on the incidence side, a peripheral edge of the incidence opening 31 serves as a boundary between the transmitting area 22 and the shielding area 21.

The second shielding film 28 is provided on a surface (a back surface) of the glass substrate 26 facing the image sensor 16 and is obtained by alternately stacking metal films having great absorption coefficients and transparent dielectric films in large numbers in the same manner as the first shielding film 27, and is an absorbing film for absorbing almost all of light within wavelength ranges having a sensitivity to the image sensor 16. A plurality of emission openings 32 is formed on the second shielding film 28 and a portion for transmitting an incident light therethrough is limited to the emission opening 32. Each of the emission openings 32 takes a circular shape and a diameter D2 of the emission opening 32 is smaller than a diameter D1 of the incidence opening 31, and the emission opening 32 is arranged in such a manner that a central position is coincident with positions of a center of each pixel 17 and that of the incidence opening 31.

The incident angle-dependent reflecting film 29 is provided to cover all the second shielding film 28 and the emission openings 32 on the surface of the glass substrate 26 facing the image sensor 16. The incident angle-dependent reflecting film 29 is obtained by stacking a plurality of dielectric films having different refractive indices and is an infrared ray cut filter film for transmitting or reflecting an infrared ray corresponding to an incident angle.

As shown in FIG. 4, the incident angle-dependent reflecting film 29 has a layer structure determined to transmit any of infrared rays having a wavelength of 850 nm which has a smaller incident angle than approximately 18 degrees and is incident on the incident angle-dependent reflecting film 29 almost vertically and to reflect any of the infrared rays which has a greater incident angle than approximately 18 degrees and is incident with a tilt to the incident angle-dependent reflecting film 29 when the infrared rays are incident. A material, a layer structure and a characteristic of the incident angle-dependent reflecting film 29 are determined corresponding to a wavelength of light to be used, a thickness of the glass substrate 26, an array interval between the incidence openings 31 (the emission openings 32) and relative sizes of the incidence opening 31 and the emission opening 32.

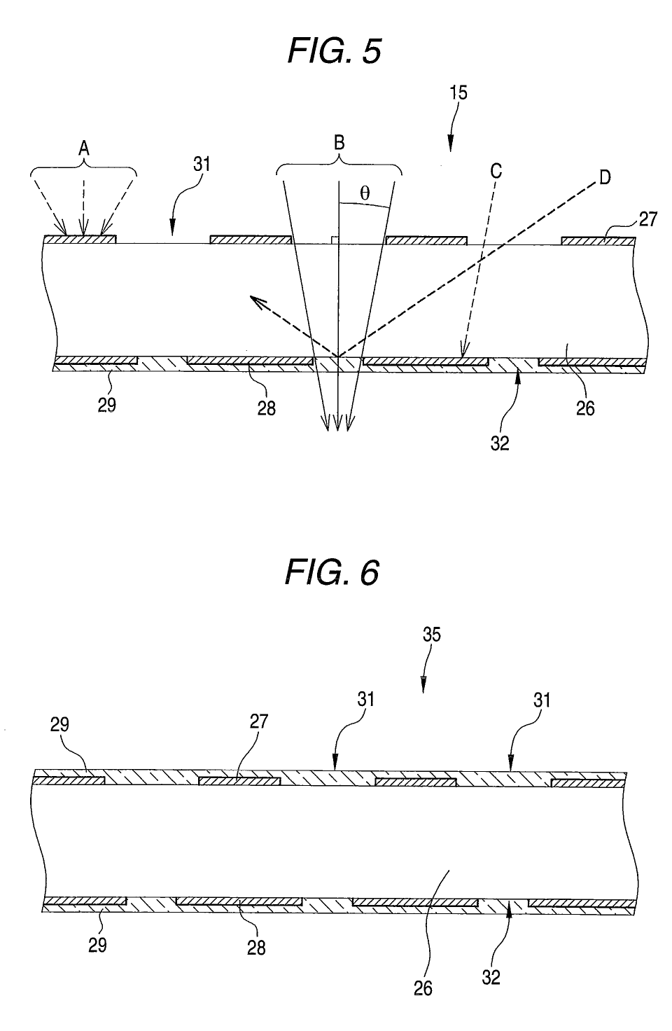

In the angle limiting filter 15 having the structure described above, infrared rays A to D having a wavelength of 850 nm are incident on various incident positions at various incident angles as shown in FIG. 5.

When an incident position is covered with the first shielding film 27, the infrared ray such as the infrared ray A is absorbed by the first shielding film 27 irrespective of the incident angle. For this reason, the infrared ray A is not transmitted toward the image sensor 16. On the other hand, the infrared rays which are incident on the incidence opening 31, for example, the infrared rays B to D are not absorbed by the first shielding film 27 but enter the glass substrate 26.

The infrared ray B which is incident on the incidence opening 31, has a smaller incident angle than an angle θ (approximately 18 degrees) determined by the incident angle-dependent reflecting film 29 and is incident on the angle limiting filter 15 almost vertically is transmitted through the glass substrate 26 and then reaches the emission opening 32. At this time, the incident angle of the infrared ray B on the incident angle-dependent reflecting film 29 is almost equal to an incident angle on the angle limiting filter 15 and is smaller than approximately 18 degrees. Therefore, the infrared ray B is transmitted through the incident angle-dependent reflecting film 29 and is emitted to the image sensor 16.

When an incident position is the incidence opening 31 and an incident angle is equal to or smaller than approximately 18 degrees, and a position that the infrared ray C reaches after a transmission through the glass substrate 26 is covered with the second shielding film 28, however, the infrared ray C is absorbed, and therefore, is not emitted toward the image sensor 16. When the infrared ray D is incident in the incidence opening 31 with a tilt at a greater incidence angle than approximately 18 degrees, it is reflected into the glass substrate 26 through the incident angle-dependent reflecting film 29 and is not emitted toward the image sensor 16 even if it reaches the emission opening 32.

Thus, the angle limiting filter 15 limits any of the infrared rays which is incident at various angles and is emitted toward the image sensor 16 to be an infrared ray which has a smaller angle than an angle determined by the incident angle-dependent reflecting film 29, that is, approximately 18 degrees and is incident almost vertically.

At this time, the infrared ray which is incident from the incidence opening 31 provided in a non-corresponding position, for example, the incidence opening 31 corresponding to the adjacent emission opening 32 to the certain emission opening 32 is reflected by the incident angle-dependent reflecting film 29 and is not emitted toward the image sensor 16. By using the angle limiting filter 15, therefore, the infrared ray which is incident on each pixel 17 is not superposed on light which is incident on the surrounding pixels 17 but corresponds to a single portion of the object 11 almost one-on-one so that a noise to deteriorate a resolution, for example, a halation or a blur can be relieved to carry out imaging.

By setting the diameter of the emission opening 32 to be smaller than that of the incidence opening 31, it is possible to collect the vertical incident light 19 and to cause the vertical incident light 19 to be incident on the image sensor 16.

The angle limiting filter 15 does not require a mechanical processing such as a through hole or polishing. Therefore, it is possible to manufacture the angle limiting filter 15 easily and inexpensively by patterning a thin film on the glass substrate 26. In addition, the angle limiting filter 15 does not have a deep hole such as the through hole but has an almost flat surface. Even if refuse and dust stick, therefore, it is possible to easily remove them by blowing air or ultrasonic cleaning. Therefore, the angle limiting filter 15 has high yield and is suitable for a mass production.

Although the incident angle-dependent reflecting film 29 is provided on the surface (the back surface) of the glass substrate 26 facing the image sensor 16 in the first embodiment, the invention is not limited to this configuration but the incident angle-dependent reflecting film 29 may be provided on only the surface (the front surface) facing the object 11 and may be provided on both the surface facing the image sensor 16 and the surface facing the object 11. In this case, it is possible to produce the same advantages as those in the embodiment. When the glass substrate 26 is thin and a warpage is generated on the angle limiting filter 15 if the incident angle-dependent reflecting film 29 is provided on only one of the surfaces, particularly, it is preferable to provide the incident angle-dependent reflecting film 29 on both the surface facing the image sensor 16 and the surface facing the object 11 as in an angle limiting filter 35 shown in FIG. 6.

When a dielectric film such as the incident angle-dependent reflecting film 29 is stacked on both surfaces of the glass substrate 26 in order to prevent the warpage of the angle limiting filter 15, it is preferable that the incident angle-dependent reflecting film 29 should be provided on one surface of the glass substrate 26 and a dielectric multilayer film having another optical function, for example, a visible light cut filter or a band-pass filter should be provided on the other surface. For example, as described in the first embodiment, the incident angle-dependent reflecting film 29 is provided on the surface of the glass substrate 26 facing the image sensor 16 and the band-pass filter 14 is provided integrally with the angle limiting filter 15 on the surface of the glass substrate 26 facing the object 11. Thus, the dielectric multilayer film having another optical function is provided on the surface of the glass substrate 26 in addition to the incident angle-dependent reflecting film 29. Consequently, it is possible to reduce the number of components in the contact type scanner 10 and to cause the contact type scanner 10 to be more compact.

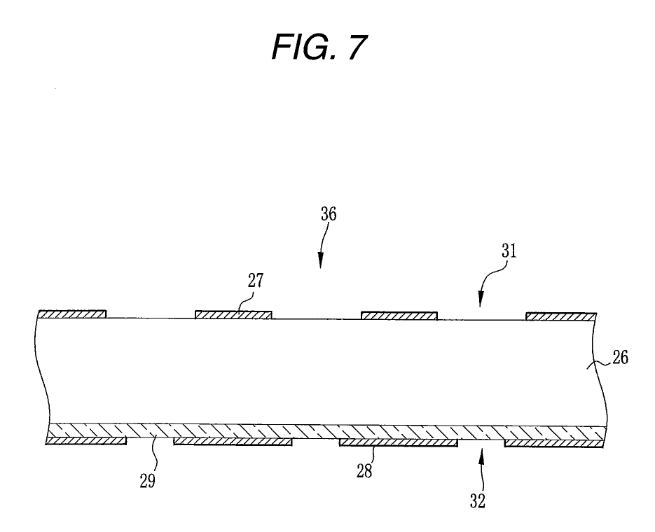

Although the second shielding film 28 is provided on the surface of the glass substrate 26 facing the image sensor 16 and the incident angle-dependent reflecting film 29 is provided to cover the second shielding film 28 in the first embodiment, the position where the incident angle-dependent reflecting film 29 is provided is not limited to this configuration. For example, like an angle limiting filter 36 shown in FIG. 7, by providing the incident angle-dependent reflecting film 29 on the surface of the glass substrate 26 and providing the second shielding film 28 thereon, the stacking order of the incident angle-dependent reflecting film 29 and the second shielding film 28 may be reversed. Although the incident angle-dependent reflecting film 29 is provided on the surface facing the image sensor 16, the incident angle-dependent reflecting film 29 may be provided on the surface facing the object 11. Accordingly, when the incident angle-dependent reflecting film 29 may be provided on the surface facing the object 11, the incident angle-dependent reflecting film 29 and the first shielding film 27 are stacked sequentially from the glass substrate 26 on the surface of the glass substrate 26 facing the object 11 and the second shielding film 28 may be stacked on the surface facing the image sensor 16.

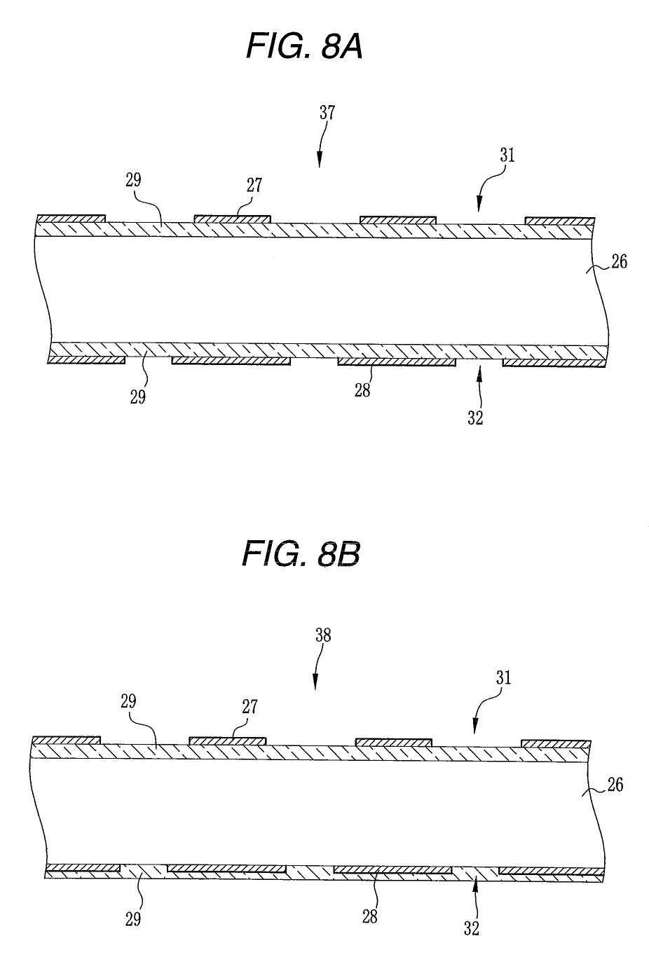

As described above, when the incident angle-dependent reflecting film 29 is provided on both surfaces of the glass substrate 26, the incident angle-dependent reflecting film 29 may be provided on the surface of the glass substrate 26 and the first shielding film 27 and the second shielding film 28 may be provided thereon, like the angle limiting filter 37 shown in FIG. 8A. In this way, when the incident angle-dependent reflecting film 29 is provided on both surfaces of the glass substrate 26, the stacking order of the incident angle-dependent reflecting film 29 and the shielding film on the glass substrate 26 may be different on both surfaces of the glass substrate 26. For example, like an angle limiting filter 38 shown in FIG. 8B, the incident angle-dependent reflecting film 29 and the first shielding film 27 may be stacked sequentially from the glass substrate 26 on the surface of the glass substrate 26 facing the object 11 and the second shielding film 28 and the incident angle-dependent reflecting film 29 may be stacked sequentially from the glass substrate 26 on the surface facing the image sensor 16. Similarly, the first shielding film 27 and the incident angle-dependent reflecting film 29 may be stacked sequentially from the glass substrate 26 on the surface of the glass substrate 26 facing the object 11 and the incident angle-dependent reflecting film 29 and the second shielding film 28 may be stacked sequentially from the glass substrate 26 on the surface facing the image sensor 16.

Although the diameter D2 of the emission opening 32 is smaller than the diameter D1 of the incidence opening 31 in the first embodiment, the invention is not limited to this configuration but the diameter of the incidence opening 31 may be equal to the diameter of the emission opening 32 or the diameter D2 of the emission opening 32 may be set greater than the diameter D1 of the incidence opening 31, depending on usage of the emitted light.

### Second Embodiment

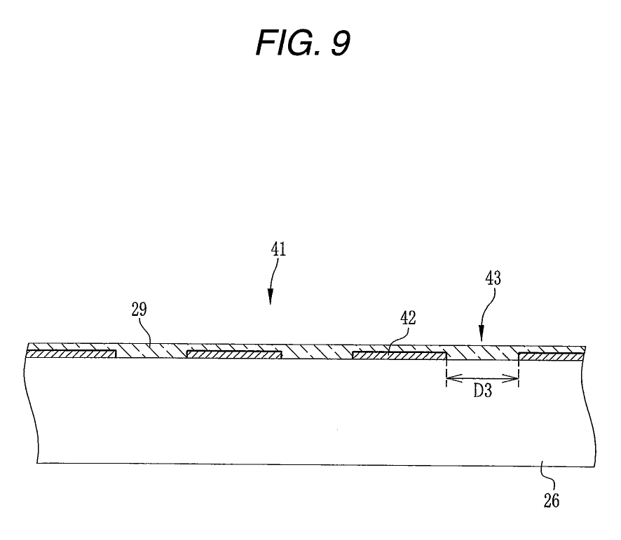

Although the first shielding film 27 and the second shielding film 28 are provided in the outside and the inside of the glass substrate 26 in the first embodiment, the invention is not limited to this configuration but the shielding film may be provided on only one surface of the glass substrate 26. An example where the shielding film is provided on one surface of the glass substrate 26 will be described now as a second embodiment of the invention. For example, in an angle limiting filter 41 shown in FIG. 9, a shielding film 42 is provided on the surface of the glass substrate 26 facing the object 11 and no shielding film is provided on only the surface facing the image sensor 16, unlike the above-mentioned angle limiting filters 15 and 35. The incident angle-dependent reflecting film 29 is provided on the surface of the glass substrate 26 facing the object 11 so as to cover the entire shielding film 42.

The shielding film 42 provided in the angle limited filter 41 is obtained by repeatedly alternately stacking a metal film having a high absorption coefficient and a transparent dielectric film, like the first shielding film 27 or the second shielding film 28, and serves as an absorbing film absorbing almost all light in a wavelength range having sensitivity to the image sensor 16. The shielding film 42 is provided with plural circular openings 43 at a constant interval of which the center positions coincide with the center positions of the pixels 17. Here, the diameter D3 of the openings 43 provided in the shielding film 42 is smaller than the diameter D1 of the incidence openings 31 provided in the first shielding film 27 and is greater than the diameter D2 of the emission openings 32 provided in the second shielding film 28.

The incident angle-dependent reflecting film 29 provided in the angle limiting filter 41 is formed by stacking plural dielectric films having different refractive indexes, similarly to those provided in the above-mentioned angle limiting filters 15 and 35, and serves as an infrared ray cut filter film transmitting or reflecting an incident infrared ray depending on the incidence angle thereof.

The angle limiting filter 41 having the above-mentioned configuration is disposed on the front surface of the image sensor 16 with the surface, which is provided with the shielding film 42 and the incident angle-dependent reflecting film 29, directed to the object 11. Infrared rays are incident on the angle limiting filter 41 from the object 11 at various angles. At this time, the infrared ray incident on the incident angle-dependent reflecting film 29 obliquely at an angle greater than a predetermined angle is reflected by the incident angle-dependent reflecting film 29 and thus does not reach the shielding film 42. On the other hand, the infrared ray incident on the incident angle-dependent reflecting film 29 almost vertically at an angle less than the predetermined angle passes through the incident angle-dependent reflecting film 29. Among the infrared rays passing through the incident angle-dependent reflecting film 29, the infrared ray incident on the shielding film 42 is absorbed by the shielding film 42. On the other hand, among the infrared rays passing through the incident angle-dependent reflecting film 29, the infrared rays incident on the openings 43 pass through the openings 43 and reach the image sensor 16. At this time, the infrared rays passing through the openings 43 are incident on the pixels 17 provided just below the openings 43 through which the infrared rays pass.

The incidence angles of the infrared rays incident on the image sensor 16 from the object 11 are limited to the direction almost vertical to the image sensor 16 by the angle limiting filter 41. At the same time, in a contact type scanner mounted with the angle limiting filter 41, since the infrared rays from the object 11 are incident on the image sensor 16 so as to allow positions of the object 11 to correspond to the pixels 17 of the image sensor 16 in a one-to-one manner by the use of the angle limiting filter 41, it is possible to reduce a noise deteriorating a resolution, such as a halation or a blur and to carry out imaging.

Since the manufacturing of the angle limiting filter 41 does not require mechanical processing such as formation of a through hole or polishing, it is possible to easily and inexpensively manufacture the angle limiting filter, similarly to the angle limiting filters 15 and 35 according to the first embodiment.

On the other hand, although the first shielding film 27 and the second shielding film 28 are provided on both surfaces of the glass substrate 26 in the angle limiting filters 15 and 35 according to the first embodiment, the shielding film 42 is provided on only one surface of the glass substrate 26 on the surface facing the object 11 in the angle limiting filter 41. Accordingly, the incident angle selectivity of an infrared ray incident on the image sensor 16 from the object 11 is more excellent in the angle limiting filter 15 according to the first embodiment than the angle limiting filter 41. However, the first shielding film 27 and the second shielding film 28 should be provided on both surfaces of the glass substrate 26 in the angle limiting filters 15 and 35 so as to align the incidence openings 31 and the emission openings 32 corresponding to each other, but the shielding film 42 is provided on only the surface facing the object 11 and the alignment of the shielding films is not required for the angle limiting filter 41. Accordingly, it is possible to easily and stably manufacture the angle limiting filter 41 at lower cost than that of the angle limiting filters 15 and 35 according to the first embodiment. Therefore, the angle limiting filter 41 can limit the incident angles of the infrared rays on the image sensor 16 to an imaging range with a practical resolution and can be easily and stably manufactured at low cost.

In the second embodiment, the size of the openings 43 formed in the shielding film 42 is a middle size between the sizes of the openings 31 and 32 formed in two shielding films 27 and 28 according to the first embodiment, but the size of the openings 43 is not limited to this size. It is preferable that the size of the openings 43 is determined depending on the resolution or light intensity required for imaging and the sensitivity of the image sensor 16 and that it is a middle size between the sizes of the openings 31 and 32, as described above, when the same image sensor 16 as the contact type scanner 10 according to the first embodiment is used under the same condition.

In the second embodiment, the shielding film 42 and the incident angle-dependent reflecting film 29 are provided on the surface of the glass substrate 26 facing the object 11 and the shielding film and the like are not provided on the other surface of the image sensor 16. However, the surface provided with the shielding film 42 or the incident angle-dependent reflecting film 29 is not limited to the surface facing the object 11, but the shielding film 42 and the incident angle-dependent reflecting film 29 may be provided on the surface of the image sensor 16 and the shielding film or the like may not be provided on the surface facing the object 11. However, when the shielding film 42 and the incident angle-dependent reflecting film 29 are provided on only the surface of the glass substrate 26 facing the object 11, the incident angle of the infrared rays on the image sensor 16 from the object 11 can be better limited than the case where the shielding film 42 and the incident angle-dependent reflecting film 29 are provided on only the surface of the glass substrate 26 facing the image sensor 16. Accordingly, when the shielding film is provided on only one surface of the glass substrate 26, it is preferable that the shielding film 42 and the incident angle-dependent reflecting film 29 are provided on the surface facing the object 11, similarly to the angle limiting filter 41 according to the second embodiment.

In the second embodiment, the shielding film 42 and the incident angle-dependent reflecting film 29 are provided on the surface facing the object 11 and the shielding film or the like is not provided on the other surface of the image sensor 16. However, when the shielding film 42 or the like is provided on only one surface of the glass substrate 26, a warpage may occur in the angle limiting filter 41. Accordingly, it is preferable that the warpage of the angle limiting filter 41 is prevented by providing a thin film having an optical function on both surfaces of the glass substrate 26 such as providing the shielding film 42 on one surface of the glass substrate 26 and providing the incident angle-dependent reflecting film 29 on the other surface.

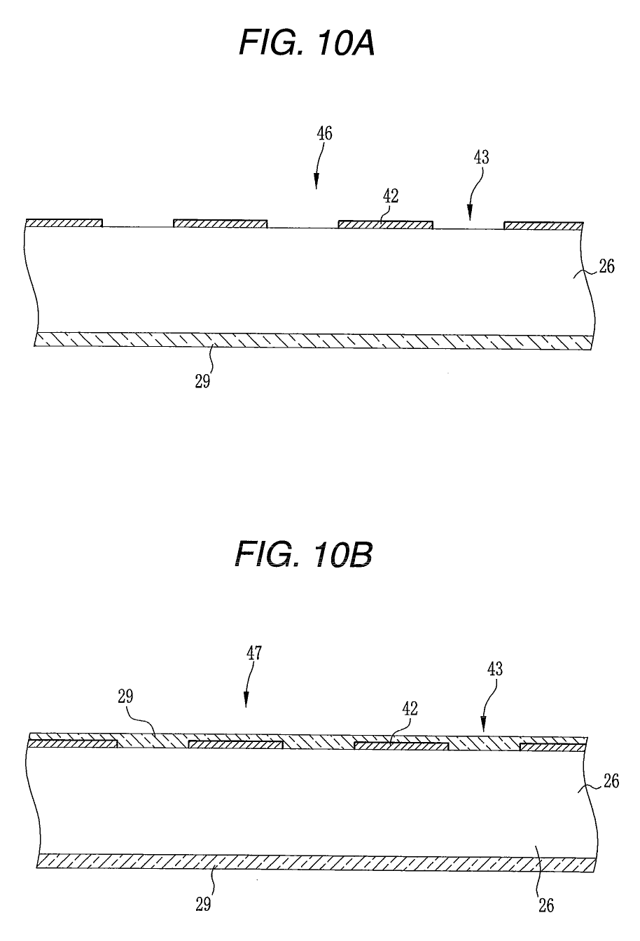

For example, like an angle limiting filter 46 shown in FIG. 10A, the warpage of the angle limiting filter may be reduced by providing only the shielding film 42 on the surface of the glass substrate 26 facing the object 11 and providing the incident angle-dependent reflecting film 29 on the surface facing the image sensor 16. In this way, when the incident angle-dependent reflecting film 29 and the shielding film 42 are provided on both surfaces of the glass substrate 26, respectively, the incident angle-dependent reflecting film 29 may be provided on the surface of the glass substrate 26 facing the object 11 and the shielding film 42 may be provided on the surface facing the image sensor 16, unlike the angle limiting filter 46.

For example, like an angle limiting filter 47 shown in FIG. 10B, the warpage of the angle limiting filter may be reduced by providing the incident angle-dependent reflecting film 29 on both surfaces of the glass substrate 26. Here, the angle limiting filter 47 in which the shielding film 42 is provided on the surface facing the object 11 is taken as an example, but the warpage of the angle limiting filter may be reduced by also providing the incident angle-dependent reflecting film 29 on both surfaces of the glass substrate 26 when the shielding film 42 is provided on the surface facing the image sensor 16.

For example, like the angle limiting filter 41 according to the second embodiment, by providing the shielding film 42 and the incident angle-dependent reflecting film 29 on one surface of the glass substrate 26 and providing an optical film serving as the band pass filter 14 on the other surface, the warpage of the angle limiting filter may be reduced. In this way, when the optical film serving as the band pass filter 14 is provided integrally on the angle limiting filter 41, it is possible to reduce the number of components of the contact type scanner, as well as to reduce the warpage of the angle limiting filter. Accordingly, the contact type scanner can be constructed with a smaller thickness and at low cost.

In the angle limiting filters 15, 35, 36, 37, and 38 according to the first embodiment, the angle limiting filters 15 and 35 and the band pass filter 14 may be integrally formed by providing the incident angle-dependent reflecting film 29 on both surfaces of the glass substrate 26 to prevent the warpage of the angle limiting filters or providing the optical film 57 serving as the band pass filter 14 to reduce the number of components or the cost.

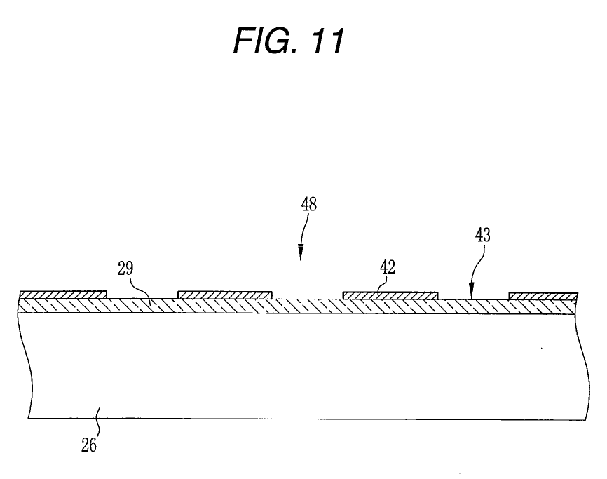

In the second embodiment, the shielding film 42 is provided on the glass substrate 26 and the incident angle-dependent reflecting film 29 is provided thereon, but the stacking order of the shielding film 42 and the incident angle-dependent reflecting film 29 is not limited to that order. When the shielding film 42 and the incident angle-dependent reflecting film 29 are together provided on one surface of the glass substrate 26, the incident angle-dependent reflecting film 29 and the shielding film 42 may be sequentially stacked from the glass substrate 26, for example, like an angle limiting filter 48 shown in FIG. 11. Here, the angle limiting filter 48 in which the incident angle-dependent reflecting film 29 and the shielding film 42 are provided on the surface facing the object 11 is taken as an example, but the incident angle-dependent reflecting film 29 and the shielding film 42 may be sequentially stacked from the glass substrate 26, similarly, when the incident angle-dependent reflecting film 29 and the shielding film 42 are provided on the surface facing the image sensor 16. Like the angle limiting filter 47 (FIG. 10B), when the incident angle-dependent reflecting film 29 is provided on both surfaces of the glass substrate 26, the shielding film 42 and the incident angle-dependent reflecting film 29 are not necessarily stacked sequentially from the glass substrate 26, but the incident angle-dependent reflecting film 29 and the shielding film 42 may be stacked sequentially from the glass substrate 26.

Although the angle limiting filters according to the first embodiment and the second embodiment include the incident angle-dependent reflecting film 29 limiting the incident angle of light to be emitted to approximately 18 degrees or less, the incident angle of light emitted from the angle limiting filter can be optionally regulated by adjusting the material or the layer structure of the incident angle-dependent reflecting film 29. While the description has been given by taking, as an example, the angle limiting filter serving for the infrared ray having a wavelength of 850 nm in the first and second embodiments, it is possible to set an angle limiting filter serving for another optional wavelength by adjusting the material and the layer structure of the incident angle-dependent reflecting film 29. Although the incident angle-dependent reflecting film 29 is constituted to serve for a single wavelength of 850 nm in the embodiment, the invention is not limited to this configuration but it is also possible to constitute the incident angle-dependent reflecting film 29 to transmit light which is incident almost vertically to light in a wavelength range having a width and to reflect light which is incident obliquely thereto with respect to light having a plurality of wavelengths by adjusting the layer structure and the material.

Although the incidence openings 31, the emission openings 32, and the openings 43 are provided to correspond to the individual pixels 17 in the first and second embodiments, the invention is not limited to this configuration. When the imaging region is divided into regions constituted by pixels to use the image sensor 16, the incidence openings 31, the emission openings 32, and the openings 43 may be provided to correspond to the divided regions. While the incidence openings 31, the emission openings 32, and the openings 43 take a circular shape in the first and second embodiments, the invention is not limited to this configuration but the openings may take other shapes such as a square shape. Although the incidence openings 31, the emission openings 32, and the openings 43 are arranged two-dimensionally in the first and second embodiments, the invention is not limited to this configuration but the incidence openings 31, the emission openings 32, and the openings 43 may be provided in a slit shape in which rectangles are arranged one-dimensionally.

Although the incidence openings 31 and the emission openings 32 are provided in such a manner that their central positions coincide with each other in order to limit the incident light 18 on the image sensor 16 to the vertical incident light 19 in the first and second embodiments, the invention is not limited to this configuration but the central positions of the incidence openings 31 and the emission openings 32 may be shifted from each other, thereby emitting the obliquely incident light 18 from the angle limiting filter 15. In this case, referring to the characteristic of the incident angle-dependent reflecting film 29, it is necessary to regulate the layer structure and the material depending on the angle of the light to be emitted from the angle limiting filter 15.

Although a CCD is used as the image sensor 16 in the first and second embodiments, the invention is not limited to this configuration but the angle limiting filter may be suitably used for other image sensors such as a CMOS.

In the first and second embodiments, the glass substrate 26 is used as the substrate of the angle limiting filter 15. The thin glass substrate 26 is apt to be broken due to a fine polishing trace which does not influence an optical function. For this reason, when the thin glass substrate 26 is used to reduce a thickness of the angle limiting filter 15, it is preferable to use a non-polished glass substrate having a surface which is not polished. A thin non-polished glass substrate to be used for the angle limiting filter 15 is particularly preferably manufactured by a float type plate manufacturing method of causing a fused nitric material to flow and float onto a fused metal and may be manufactured by press molding. When the angle limiting filter is to be manufactured by using the glass substrate 26 having such a thickness as not to cause a crack due to the polishing trace, a glass substrate having a surface polished as well as the non-polished glass substrate may be used.

In the angle limiting filters 15 according to the first and second embodiments, in order to prevent stray light, it is preferable that the characteristics of the first shielding film 27, the second shielding film 28, and the shielding film 42 should have reflectance and transmittance of 5% or less with respect to light having all wavelengths incident on the angle limiting filter.

Although the first shielding film 27, the second shielding film 28, and the shielding film 42 absorb all the incident light including the infrared rays and neither reflect nor transmit the light in the first and second embodiments, the invention is not limited to this configuration but it is preferable that the first shielding film 27, the second shielding film 28, and the shielding film 42 should have such a quality as not to transmit at least light having a wavelength to be utilized for imaging. For example, the first shielding film 27, the second shielding film 28, and the shielding film 42 may be reflecting films for reflecting the incident light having all wavelengths. Although both the first shielding film 27 and the second shielding film 28 are an absorbing film in the first embodiment, they do not need to have the same quality but one of them may be set to be the absorbing film and the other may be set to be the reflecting film. When the first shielding film 27 and the second shielding film 28 are set to be the reflecting films, thus, any of the light entering the glass substrate 26 through the incidence opening 31 and reflected by the internal surface of the glass substrate 26 is also reflected again so that a stray light is generated. For this reason, it is preferable that the first shielding film 27 and the second shielding film 28 should be the absorbing films as in the embodiment.

Although the incident angle-dependent reflecting film 29 has transmittance of approximately 0% with respect to an incident angle greater than approximately 18 degrees in the first and second embodiments, the invention is not limited to this configuration but the material and the layer structure of the incident angle-dependent reflecting film 29 may be adjusted without considering a greater incident angle than a critical angle to totally reflect the incident light.

In the specification, “almost vertical” and “vertical” do not simply imply to be close to a vertical angle to the surface of the angle limiting filters 15, 35, 36, 37, 38, 41, 46, 47, and 48 but imply an angle range determined based on a ratio of the diameters of the incidence opening 31 and the emission opening 32 (the angle limiting filters 15 and 35 according to the first embodiment), the thickness of the glass substrate 26, the sizes or the arrangement intervals of the incidence openings 31, the emission openings 32, the openings 43, and the pixels 17, and the incident angle at which the transmittance of the incident angle-dependent reflecting film 29 is steeply changed. Specifically, the terms imply an incident angle range at which the light from the adjacent incidence openings 31 does not pass through the emission openings 32 in the angle limiting filters 15 and 35 according to the first embodiment. Accordingly, it is assumed that the angle at which the light from the adjacent incidence openings 31 does not pass through the emission openings 32 in the angle limiting filters 15 and 35 according to the first embodiment and the angle at which the imaging can be carried out with a necessary resolution in the angle limiting filter 41 according to the second embodiment are included in the “almost vertical (vertical)”, regardless of an absolute value of the incident angle.

Although the incident angle-dependent reflecting film 29 is provided on the second shielding film 28 and the shielding film 42 to cover the entire second shielding film 28 and the entire shielding film 42 in the first and second embodiments, the invention is not limited to this configuration. The incident angle-dependent reflecting film 29 does not need to be provided to cover the entire surfaces of the second shielding film 28 and the shielding film 42 but is preferably provided to cover at least the emission openings 32 and the openings 43. This is true when the incident angle-dependent reflecting film 29 is provided on the first shielding film 27, similarly to the angle limiting filter 35 according to the first embodiment.

Although the incident angle-dependent reflecting film 29 is further provided on the second shielding film 28 disposed on the glass substrate 26 in the first embodiment, the stacking order of the second shielding film 28 and the incident angle-dependent reflecting film 29 is not limited to the above-mentioned order but the incident angle-dependent reflecting film 29 and the second shielding film 28 may be provided in this order from the glass substrate 26. When the stacking order of the incident angle-dependent reflecting film 29 and the second shielding film 28 is changed and thus the incident angle-dependent reflecting film 29 is provided closer to glass substrate 26 than the second shielding film 28, the light reflected from the internal surface of the glass substrate 26 hardly reaches the second shielding film 28 and is hardly absorbed by the second shielding film 28. For this reason, the light reflected from the internal surface of the glass substrate 26 may become stray light. Therefore, it is particularly preferable that the second shielding film 28 and the incident angle-dependent reflecting film 29 should be provided in this order from the glass substrate 26 as in the above-mentioned embodiments. This is true in the angle limiting filter 41 according to the second embodiment or when the incident angle-dependent reflecting film 29 is provided on the first shielding film 27.

Although the description has been given by taking, as an example, the contact type scanner 10 for picking up an image with the light reflected from the object 11 in the first and second embodiments, the invention is not limited to this configuration but the invention can also be used suitably for a contact type scanner which illuminates the object 11 from outside and picks up an image with light transmitted through the object 11.

While the description has been given by taking the CCD type area image sensor as an example of the image sensor 16 in the first and second embodiments, the invention is not limited to this configuration but the image sensor 16 may be a line image sensor and an imaging element of another well-known mechanism such as a CMOS may be used.

What is claimed is:

1. An imaging filter comprising:
a transparent substrate;
a shielding film provided on a surface of the substrate, having a plurality of openings formed with a constant size and at a constant interval, and shielding light incident on a portion other than the openings; and
a reflecting film provided on the surface of the substrate, formed of a multilayer dielectric film, and serving to transmit light having a wavelength and being incident almost vertically on the reflecting film and to reflect light having the wavelength and being incident obliquely on the reflecting film,
wherein an incident angle of light on an image sensor is limited.

2. The imaging filter according to claim 1, wherein the shielding film is provided on one of the surface of the substrate facing an object and the surface of the substrate facing the image sensor.

3. The imaging filter according to claim 2, wherein the reflecting film is provided on the shielding film so as to cover all the openings.

4. The imaging filter according to claim 1, wherein the shielding film is provided on one surface of the substrate and the reflecting film is provided on the other surface of the substrate.

5. The imaging filter according to claim 1, wherein the shielding film is provided on both surfaces of the substrate so that center positions of the openings of the shielding film coincide with each other in the inside and the outside of the substrate.

6. The imaging filter according to claim 5, wherein the diameter of the openings provided on the surface of the substrate facing the image sensor is smaller than the diameter of the openings of the shielding film provided on the surface of the substrate facing the object.

7. The imaging filter according to claim 5, wherein the reflecting film is provided on the shielding film provided on the surface of the substrate facing the image sensor so as to cover all the openings of the shielding film provided on the surface of the substrate facing the image sensor.

8. The imaging filter according to claim 5, wherein the reflecting film is provided on the shielding film provided on the surface of the substrate facing the object so as to cover all the openings of the shielding film provided on the surface of the substrate facing the subject.

9. The imaging filter according to claim 1, wherein the shielding film is an absorbing film absorbing the light having the wavelength.

10. The imaging filter according to claim 1, wherein the reflecting film is an infrared ray cut filter film transmitting an infrared ray incident almost vertically on the reflecting film and reflecting the infrared ray incident obliquely on the reflecting film.

11. The imaging filter according to claim 1, wherein the substrate is a non-polished glass substrate.
